(19) United States
(12) Patent Application Publication
(10) Pub. No.: US 2024/0300027 A1
(43) Pub. Date: Sep. 12, 2024

(54) DIAMOND COATING CUTTING TOOL

(71) Applicant: NTK CUTTING TOOLS CO., LTD., Nagoya-Shi (JP)

(72) Inventors: Kanshi Kushibiki, Aichi (JP); Ryoji Toyoda, Aichi (JP)

(73) Assignee: NTK CUTTING TOOLS CO., LTD., Nagoya-Shi (JP)

(21) Appl. No.: 18/598,521

(22) Filed: Mar. 7, 2024

(30) Foreign Application Priority Data
Mar. 10, 2023 (JP) 2023-037396

(51) Int. Cl. B23B 27/14

(52) U.S. Cl. CPC B23B 27/148; B23B 2226/18; B23B 2226/31; B23B 2228/10

(57) ABSTRACT

Provided is a diamond coating cutting tool in which the adhesiveness of a diamond layer to a base material is high.

A diamond coating cutting tool 1 includes a base material 3 made of a silicon nitride sintered body or a sialon sintered body, and a diamond layer 7 coated on a surface of the base material 3. In the base material 3, an average thermal expansion coefficient x at 25° C. to 600° C. satisfies 2.6×10⁻⁶/K≤x≤4.0×10⁻⁶/K, and the diamond layer 7 has a compressive residual stress of 50 MPa or more and 1800 MPa or less.

### BACKGROUND

### Field

The present disclosure relates to a diamond coating cutting tool.

### Description of Related Art

Japanese Patent Application Laid-Open No. H07-076775 discloses a diamond coating cemented carbide tool in which a diamond thin film is coated on a surface of a base material by a vapor phase synthesis method. In this diamond coating cemented carbide tool, nitrogen is doped in a film to adjust the residual stress during film formation when performing vapor phase synthesis on the diamond coating in order to relieve the stress of the diamond film, and a tensile stress is applied to the film to improve the adhesiveness of the film with an interface of the film base material.

Japanese Patent Application Laid-Open No. H09-234604 discloses a cutting tool made of artificial diamond coating cemented carbide. It is described that, in this cutting tool made of artificial diamond coating cemented carbide, the formation of a diamond coating by the vapor phase synthesis method is repeatedly performed multiple times to have a high compressive residual stress.

Japanese Patent Application Laid-Open No. 2021-142575 discloses a diamond coating cutting tool including a base material and a diamond layer coated on a surface of the base material. The diamond layer has a plurality of voids extending from a portion in contact with the base material in a crystal growth direction. In this diamond coating cutting tool, by setting an average interval between centers of adjacent voids to a specific range, the adhesiveness of the diamond layer to the base material is capable of being improved, and the peeling resistance is capable of being improved.

### SUMMARY

However, as in Japanese Patent Application Laid-Open No. H07-076775, in a case where the diamond coating is doped with other elements, the purity of diamond is lowered, which may affect various physical properties of the diamond coating. In addition, as in Japanese Patent Application Laid-Open No. H09-234604, there is a concern that, in a case where an excessive residual compressive stress is applied to the diamond coating, sufficient adhesiveness of the coating may not be obtained. In addition, there is a demand for a new technique having a wider application range than that of Japanese Patent Application Laid-Open No. 2021-142575.

The present disclosure has been made in view of the above-described circumstances, and an object of the present disclosure is to provide a diamond coating cutting tool in which the adhesiveness of a diamond layer to a base material is high. The present disclosure is capable of being realized as the following aspects.

[1] A diamond coating cutting tool including a base material made of a silicon nitride sintered body or a sialon sintered body; and a diamond layer coated on a surface of the base material, in which an average thermal expansion coefficient x of the base material in a temperature range of 25° C. to 600° C. satisfies 2.6×10⁻⁶/K≤x≤4.0×10⁻⁶/K, and the diamond layer has a compressive residual stress of 50 MPa or more and 1800 MPa or less.

[2] The diamond coating cutting tool set forth in [1], in which the silicon nitride sintered body or the sialon sintered body of the base material includes a first phase that contains β-silicon nitride or β-sialon, and a second phase that contains at least one selected from the group consisting of a Ti nitride, a Ti carbonitride, a Ti carbide, 12H-sialon, 15R-sialon, 21R-sialon, and α-sialon.

[3] The diamond coating cutting tool set forth in [1] or [2], in which the silicon nitride sintered body or the sialon sintered body of the base material is a silicon nitride sintered body that contains Al in 2% by mass or more and 35% by mass or less as converted to oxide, or a sialon sintered body that contains Al in 2% by mass or more and 35% by mass or less as converted to oxide.

[4] The diamond coating cutting tool set forth in any one of [1] to [3], in which the silicon nitride sintered body or the sialon sintered body of the base material is a silicon nitride sintered body that contains at least one selected from a Ti nitride, a Ti carbonitride, and a Ti carbide in a total of 5% by mass or more and 20% by mass or less, or a sialon sintered body that contains at least one selected from a Ti nitride, a Ti carbonitride, and a Ti carbide in a total of 5% by mass or more and 20% by mass or less.

The diamond coating cutting tool of the present disclosure has high adhesiveness of the diamond layer to the base material.

### BRIEF DESCRIPTION OF DRAWINGS

FIG. 1 is a perspective view of an example of a diamond coating cutting tool.

FIG. 2 is a sectional view of the example of the diamond coating cutting tool.

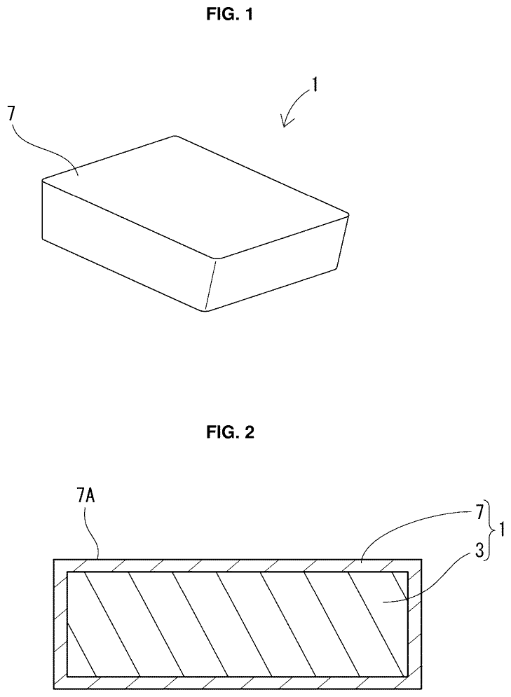

### DETAILED DESCRIPTION

### 1. Diamond Coating Cutting Tool 1

### (1) Configuration of Diamond Coating Cutting Tool 1

A diamond coating cutting tool 1 includes a base material 3 made of a silicon nitride sintered body or a sialon sintered body, and a diamond layer 7 coated on a surface of the base material 3. The base material 3 satisfies the following relational expression 1 for an average thermal expansion coefficient x in a range of 25° C. to 600° C.

2.6×10⁻⁶/K≤x≤4.0×10⁻⁶/K Relational expression 1

Moreover, the diamond layer 7 has a compressive residual stress of 50 MPa or more and 1800 MPa or less.

### (2) Base Material 3

### (2.1) Average Thermal Expansion Coefficient x of Base Material 3

As described above, from the viewpoint of improving the adhesiveness of the diamond layer 7 to the base material 3, the average thermal expansion coefficient x of the base material 3 in a range of 25° C. to 600° C. satisfies preferably the above relational expression 1, more preferably the following relational expression 2, and still more preferably the following relational expression 3. The average thermal expansion coefficient x is capable of being measured using a thermo mechanical analysis (TMA).

$$2.8 \times {10}^{- 6} / K \leq x \leq 3.7 \times {10}^{- 6} / K \qquad Relational expression 2$$

$$3. \times {10}^{- 6} / K \leq x \leq 3.5 \times {10}^{- 6} / K \qquad Relational expression 3$$

The average thermal expansion coefficient x of the base material 3 is capable of being controlled by adjusting the type of components of the base material 3 and the content of each component. In the following description, Ti nitride, Ti carbonitride, and Ti carbide are also referred to as Ti compounds. In addition, 12H-sialon, 15R-sialon, and 21R-sialon are also referred to as polytype sialon.

The β-silicon nitride and β-sialon tend to have a relatively small thermal expansion coefficient, and the Ti compounds, the polytype sialon, and the α-sialon tend to have a relatively large thermal expansion coefficient.

Thus, for example, in a case where the total content of the β-silicon nitride and the β-sialon in the base material 3 is decreased and the total content of the Ti compounds, the polytype sialon, and the α-sialon is increased, the average thermal expansion coefficient x is capable of being increased. In addition, for example, in a case where the total content of the β-silicon nitride, the β-sialon, and the α-sialon in the base material 3 is increased and the total content of the Ti compounds and the polytype sialon is decreased, the average thermal expansion coefficient x is capable of being decreased.

### (2.2) Preferred Configuration Example of Base Material 3

It is preferable that the base material 3 includes a first phase that contains β-silicon nitride or β-sialon and a second phase that contains at least one selected from the group consisting of Ti nitride, Ti carbonitride, Ti carbide, 12H-sialon, 15R-sialon, 21R-sialon, and α-sialon.

The area ratio of the first phase and the area ratio of the second phase are not particularly limited as long as the above relational expression 1 is satisfied. From the viewpoint of increasing the toughness, the area ratio of the first phase is preferably 50% or more in a case where the area of the entire base material 3 is 100%. The upper limit value of the area ratio of the above first phase is not particularly limited, and may be, for example, 95% or less. The area ratio of the second phase is preferably 40% or less in a case where the area of the entire base material 3 is 100%. The lower limit value of the area ratio of the above second phase is not particularly limited, and may be larger than 0%, for example, 5% or more.

The area ratio of the first phase and the second phase is capable of being calculated by imaging the cut surface of the base material 3 with a scanning electron microscope at a magnification of 2000 times and performing image analysis.

The total content of the β-silicon nitride and the β-sialon in the first phase is not particularly limited. The above content in the first phase is preferably 60% by mass or more. The upper limit value of the above content in the first phase is not particularly limited, and may be 100% by mass or less.

The total content of the Ti compounds, the polytype sialon, and the α-sialon in the second phase is not particularly limited. The above content in the second phase is preferably 60% by mass or more. The upper limit value of the above content in the second phase is not particularly limited, and may be 100% by mass or less.

The base material 3 including the second phase is capable of being manufactured, for example, by using the following raw materials according to a method of manufacturing the diamond coating cutting tool 1 to be described below.

In a case where the second phase contains a Ti compound, the Ti compound may be used as the raw material. In this way, the blended Ti compound may directly constitute the second phase.

In a case where the second phase contains the polytype sialon or the α-sialon, an Al compound and a compound of a specific rare earth element may be used as the raw material. For example, in a case where a lanthanum (La) compound is used as the compound of the specific rare earth element, the polytype sialon tends to be easily generated. In addition, in a case where at least one compound selected from the group consisting of Y (yttrium), Dy (dysprosium), and Er (erbium) is used as the compound of the specific rare earth element, the α-sialon tends to be easily generated. In this way, the generated polytype sialon or α-sialon can constitute the second phase.

The silicon nitride sintered body constituting the base material 3 is, for example, a sintered body in which the total amount of the β-silicon nitride and the α-silicon nitride is 50% by mass or more with respect to the entire silicon nitride sintered body. The sialon sintered body constituting the base material 3 is, for example, a sintered body in which the total amount of the β-sialon, the α-sialon, and the polytype sialon is 50% by mass or more with respect to the entire sialon sintered body.

The silicon nitride (Si₃N₄) in the silicon nitride sintered body is a ceramic crystal particle consisting of Si (silicon) and N (nitrogen), and is sintered by adding a sintering aid or the like to the silicon nitride serving as a raw material. An α-phase having an equiaxed particle shape and a β-phase having a needle-like particle shape are present in the silicon nitride, and the properties of toughness and hardness are capable of being controlled by the composition ratio of the α-phase and the β-phase. Since the β-silicon nitride has a tissue in which a needle-like tissue is entangled, the β-silicon nitride has high toughness, and since the α-silicon nitride has the equiaxed particle shape, the α-silicon nitride has lower toughness but has higher hardness, as compared to the β-silicon nitride. The silicon nitride contained in the silicon nitride sintered body is not particularly limited in terms of crystal phase types and composition ratios.

The silicon nitride sintered body may contain at least one or more element (hereinafter, may be referred to as “specific elements”) selected from the group consisting of group 4 elements, rare earth elements, and magnesium (Mg) in the periodic table. The content percentage of the specific element is not particularly limited, and may be, for example, contained in a range of 0.5 mol % or more and less than 2.6 mol % as converted to oxide with respect to the silicon nitride sintered body. The periodic table referred to herein is based on “Inorganic Chemistry Nomenclature-IUPAC 1990 Recommendations” written by G. J. Leich, translated and authored by Kazuo Yamazaki, and published on Mar. 26, 1993, and “Designation of Groups in the Periodic Table” in Table 1-3.2 published by Tokyo Kagaku Dojin Co., Ltd., and described on page 43.

Suitable examples of the group 4 elements of the periodic table which is one of the specific elements may include titanium (Ti), zirconium (Zr), hafnium (Hf), and the like. Examples of the rare earth elements may include scandium (Sc), yttrium (Y), lanthanoid, and actinoid. Examples of the lanthanoid may include a cerium group element and a yttrium group element, examples of the cerium group element may include lanthanum (La), cerium (Ce), praseodymium (Pr), neodymium (Nd), promethium (Pm), and samarium (Sm), and examples of the yttrium group element may include europium (Eu), gadolinium (Gd), terbium (Tb), dysprosium (Dy), holmium (Ho), erbium (Er), thulium (Tm), ytterbium (Yb), and lutetium (Lu). Examples of the actinoid may include actinium (Ac), thorium (Th), and the like. The “converted to oxide” means that an element is oxidized or converted to oxide bonded to oxygen.

One type of element of the specific elements may be included in the silicon nitride sintered body alone, or a plurality of types of elements of the specific elements may be included in the silicon nitride sintered body.

From the following viewpoint, the silicon nitride sintered body contains at least one selected from the group consisting of Ti (titanium) nitride, Ti carbonitride, and Ti carbide in preferably a total of 5% by mass or more and 20% by mass or less, more preferably a total of 5% by mass or more and 15% by mass or less, and still more preferably a total of 10% by mass or more and 15% by mass or less. In a case where the silicon nitride sintered body contains the Ti compounds (titanium) in the above-described range, further peeling resistance is capable of being expected. That is, as the matrix silicon nitride (α-silicon nitride or β-silicon nitride) having a thermal expansion coefficient smaller than the thermal expansion coefficient of the diamond layer 7 and the above Ti (titanium) compounds having a thermal expansion coefficient larger than the thermal expansion of the diamond layer 7 are made composite, the thermal expansion coefficient of the entire sintered body is within the range of the above relational expression 1 while the tensile stress and the compressive stress are randomly applied and the stresses are offset. As a result, further peeling resistance is capable of being expected.

Suitable examples of the Ti (titanium) nitride, the Ti carbonitride, and the Ti carbide include TiC^{x}N₍₁₋ₓ₎ (0≤X≤1).

The sialon (SiAlON) in the sialon sintered body is a ceramic crystal particle consisting of Si (silicon), Al (aluminum), O (oxygen), and N (nitrogen). The sialon is formed by adding a sintering aid or the like to raw material powder containing constituent elements such as silicon nitride, alumina, aluminum nitride, Si such as silica, Al, O, and N, which are raw materials, and sintering the raw material powder. β-sialon represented by a composition formula Si_{6-Z}Al_{Z}O_{Z}N_{8-Z} (0<Z≤4.2), and α-sialon represented by a composition formula Mx(Si, Al)₁₂(O, N)₁₆ (0<X≤2, M indicates an interstitial element such as Mg, Ca, Sc, Y, Dy, Er, Yb, or Lu, which is solid-solved) are present in the sialon particles.

Since the β-sialon has a tissue in which a needle-like tissue is entangled similar to the silicon nitride, the β-sialon has high toughness, and since the α-sialon has an equiaxed particle shape, the α-sialon has lower toughness but has higher hardness, as compared to the β-sialon. In the sialon, the ratio of the α-sialon to the β-sialon is not particularly limited.

The sialon sintered body may contain a rare earth element used as the sintering aid, for example, at least one element selected from the group consisting of Sc, Y, Dy, Yb, Er, Sm, Ce, and Lu in 1% by mass or more and 10% by mass or less as converted to oxide.

From the viewpoint of further improving the peeling resistance of the diamond layer 7, the sialon sintered body contains Al (aluminum) in preferably 2% by mass or more and 35% by mass or less, more preferably 5% by mass or more and 30% by mass or less, and still more preferably 15% by mass or more and 25% by mass or less of Al as converted to oxide.

From the following viewpoint, the sialon sintered body contains at least one selected from the Ti (titanium) nitride, the Ti carbonitride, and the Ti carbide in preferably a total of 5% by mass or more and 20% by mass or less, more preferably a total of 5% by mass or more and 15% by mass or less, and still more preferably a total of 5% by mass or more and 10% by mass or less. In a case where the above sialon sintered body contains the above Ti (titanium) compounds in the above range, further peeling resistance is capable of being expected. That is, as the matrix sialon sintered body having a thermal expansion coefficient smaller than the thermal expansion coefficient of the diamond layer 7 and the above Ti (titanium) compounds having a thermal expansion coefficient larger than the thermal expansion of the diamond layer 7 are made composite, the thermal expansion coefficient of the entire sintered body is within the range of the above relational expression 1 while the tensile stress and the compressive stress are randomly applied and the stresses are offset. As a result, further peeling resistance is capable of being expected.

Suitable examples of the Ti (titanium) nitride, the Ti carbonitride, and Ti carbide include TiC_{X}N_{(1-X)} (0≤X≤1).

From the viewpoint of further improving the peeling resistance, the sialon sintered body preferably includes the crystal phase of the polytype sialon. The polytype sialon is preferably at least one selected from the group consisting of 12H, 15R, and 21R. That is, the sialon sintered body preferably includes at least one polytype sialon selected from the group consisting of 12H-sialon (general formula: SiAl₅O₂N₅), 15R-sialon (general formula: SiAl₄O₂N₄), and 21R-sialon (general formula: SiAl₆O₂N₆).

As the sialon sintered body includes the polytype crystal phase, further peeling resistance is capable of being expected. That is, as the matrix β-sialon having a relatively small thermal expansion coefficient and the sialon (polytype sialon and α-sialon) having a relatively large thermal expansion coefficient are made composite, the thermal expansion coefficient of the entire sintered body is within the range of the above relational expression 1 while the tensile stress and the compressive stress are randomly applied and the stresses are offset. As a result, further peeling resistance is capable of being expected.

The polytype crystal phase contained in the sialon sintered body is capable of being identified by performing X-ray diffraction analysis on the sintered body.

### (3) Diamond Layer 7

The diamond layer 7 has a compressive residual stress of 50 MPa or more and 1800 MPa or less. The diamond layer 7 preferably has a compressive residual stress of 150 MPa or more and 1600 MPa or less and more preferably a compressive residual stress of 300 MPa or more and 1400 MPa or less.

The residual stress of the diamond layer 7 is measured by the sin²Ψ method. The measurement point is a position from the cutting edge of the diamond coating cutting tool 1 to 1500 μm on a rake face 7A of the diamond coating cutting tool 1. The residual stress is measured by an X-ray diffraction device using Cu-Kα rays. In the diamond coating cutting tool including cemented carbide as a base material, since Co (cobalt) included in the base material overlaps a crystal plane of diamond, it is difficult to measure the compressive stress by the above measurement method. In the diamond coating cutting tool 1 of the present disclosure, it is desirable that Co is not contained in order to accurately evaluate the residual stress.

The compressive residual stress of the diamond layer 7 is capable of being controlled, for example, by adjusting the above thermal expansion coefficient of the base material 3. In a case where the thermal expansion coefficient of the base material 3 is increased, the compressive residual stress of the diamond layer 7 is capable of being increased. In addition, in a case where the thermal expansion coefficient of the base material 3 is decreased, the compressive residual stress of the diamond layer 7 is capable of being decreased.

In addition, the residual stress of the diamond layer 7 is capable of being controlled by, for example, a coating post-treatment to be described below. In a case where the irradiation pressure in the blast treatment is increased, the compressive residual stress tends to be increased, and in a case where the irradiation pressure is decreased, the compressive residual stress tends to be decreased. In addition, in a case where the irradiation time in the blast treatment is increased, the compressive residual stress tends to be increased, and in a case where the irradiation time is decreased, the compressive residual stress tends to be decreased.

The diamond layer 7 preferably has a multilayer structure in order to reduce the surface roughness of a film and provide high film toughness. The diamond layer 7 preferably consists of polycrystalline diamond. Here, the polycrystalline diamond is a polycrystalline diamond in which fine diamond particles are firmly bonded. The diamond layer 7 may contain heteroatoms such as boron, nitrogen, and silicon, and inevitable impurities other than these elements.

A method of forming the diamond layer 7 is not particularly limited. A method of forming the diamond layer 7 is preferably a chemical vapor deposition (CVD) method. Examples of the CVD method include a microwave plasma CVD method, a hot filament CVD method, a high-frequency plasma CVD method, and the like. Among the CVD methods, the microwave plasma CVD method through which a film having a fine crystal particle diameter and a small surface roughness is easily obtained is suitably used.

The thickness of the diamond layer 7 is not particularly limited. The thickness of the diamond layer 7 is preferably 8 μm or more and 20 μm or less. In a case where the thickness is 8 μm or more, the adhesiveness is improved, and in a case where the thickness is 20 μm or less, the cutting performance is improved because the cutting edge is easily sharpened.

(4) Reasons for Presuming that the Configuration of the Present Disclosure Increases the Adhesiveness of the Diamond Layer 7 to the Base Material 3 and Improves the Peeling Resistance

The thermal expansion coefficient of the diamond layer 7 (diamond coating) according to the present embodiment is 3.1×10⁻⁶/K. In order to apply an appropriate compressive residual stress to the diamond layer 7 and improve the adhesiveness of the diamond layer 7 to the base material 3, it is necessary to adjust the thermal expansion coefficient of the base material 3 with respect to the diamond layer 7. That is, in a case where the thermal expansion coefficient of the base material 3 is too smaller than that of the diamond layer 7, a tensile stress is applied to the diamond layer 7, and the adhesiveness of the diamond layer 7 to the base material 3 deteriorates. In addition, in a case where the thermal expansion coefficient of the base material 3 is too large with respect to the diamond layer 7, an excessive compressive stress is applied to the diamond layer 7, and the adhesiveness of the diamond layer 7 to the base material 3 deteriorates. Thus, it is presumed that the adhesiveness of the diamond layer 7 to the base material 3 is improved by setting the average thermal expansion coefficient x of the base material 3 to the specific range shown in the above relational expression 1 and setting the compressive residual stress applied to the diamond layer 7 to 50 MPa or more and 1800 MPa or less.

In addition, it is presumed that, by improving the adhesiveness of the diamond layer 7 to the base material 3, peeling is less likely to occur not only in the initial stage of cutting but also in a case where the cutting process is continued for a long time, thereby extending the service life of the tool. In addition, since the diamond coating cutting tool 1 according to the embodiment of the present disclosure is capable of being used under more severe conditions, it is possible to increase the cutting efficiency.

### 2. Method of Manufacturing Diamond Coating Cutting Tool 1

The method of manufacturing the diamond coating cutting tool 1 is not particularly limited. An example of the method of manufacturing the diamond coating cutting tool 1 will be shown below.

### (1) Raw Material

For example, the following raw material powders are used as raw materials.
Main component: α-Si₃N₄ powder
Sintering aid: selected from Y₂O₃ (yttrium oxide), Yb₂O₃ (ytterbium oxide), La₂O₃ (lanthanum oxide), CeO₂ (cerium (IV) oxide), Sm₂O₃ (samarium oxide), Er₂O₃ (erbium oxide), Dy₂O₃ (dysprosium oxide), MgO (magnesium oxide), MgCO₃ (magnesium carbonate), Al₂O₃ (aluminum oxide), AlN (aluminum nitride), ZrO₂ (zirconium oxide), TiN (titanium nitride), and TiC (titanium carbide).

### (2) Preparation of Base Material 3

A slurry is obtained by wet-mixing a raw material powder, an organic binder dissolved in a solvent, and the solvent by a ball mill using balls. The slurry is dried, and the dried slurry is press-molded into a desired (tool) shape to obtain a molded product. The molded product is subjected to a degreasing treatment in a heating device in a predetermined atmosphere, for example, at 400° C. to 800° C. for 60 minutes to 120 minutes. Moreover, the degreased molded product is disposed in a container, and is heated in a predetermined atmosphere, for example, at 1,700° C. to 1,900° C. for 120 minutes to 360 minutes to obtain a sintered body. In a case where the theoretical density of the sintered body is less than 99%, the sintered body is further subjected to a hot isostatic pressing method (HIP treatment), for example, in a predetermined atmosphere of 1,000 atm, for example, at 1,500° C. to 1,700° C. for 120 minutes to 240 minutes to obtain a dense body having a theoretical density of 99% or more. The sintered body or the dense body prepared in this way corresponds to the base material 3.

### (3) Coating Pretreatment

A coating pretreatment may be performed on the diamond layer 7 before the coating. The coating pretreatment is performed in order to increase the adhesiveness of the diamond layer 7 to the base material 3. Specifically, a roughening treatment or the like of the surface of the base material 3 is exemplified. For example, chemical corrosion such as electropolishing or sandblasting using abrasive grains or the like made of SiC or the like is used for the roughening treatment.

### (4) Coating of Diamond Layer 7 (Formation of Diamond Layer 7)

For example, the microwave plasma CVD method is capable of being used for the coating of the diamond layer 7. For example, methane (CH₄), hydrogen (H₂), carbon monoxide (CO), or the like is supplied as a raw material gas for coating. The coating treatment is performed, for example, by repeating the following two steps. The following nucleation step and crystal growth step are repeated until a set film thickness is reached, and the diamond layer 7 having a multilayer structure is coated on the surface of the base material 3.

### (4.1) Nucleation Step

The flow rate of methane and hydrogen is adjusted such that the concentration of methane has a set value determined in a range of 10% to 30%. In this case, the surface temperature of the base material 3 is a set temperature determined in a range of 700° C. to 900° C. and the gas pressure in a reaction furnace is a set pressure determined in a range of 2.5×10² Pa to 3.0×10³ Pa, and this condition is continued for 0.1 hours to 2 hours.

### (4.2) Crystal Growth Step

The flow rate of methane and hydrogen is adjusted such that the concentration of methane has a set value in a range of 1% to 4%. In this case, crystal growth is performed under the condition that the surface temperature of the base material 3 is a set temperature determined in a range of 800° C. to 900° C., and the gas pressure in the reaction furnace is a set pressure determined in a range of 1.0×10³ Pa to 7.0×10³ Pa.

### (5) Coating Post-Treatment

The adjustment of the residual stress of the coated diamond layer 7 is carried out by the blast treatment using abrasive grains or the like made of SiC or the like. In this case, the blast treatment is performed on the surface of the diamond layer 7 at a predetermined pressure (0.1 MPa to 0.6 MPa) for a predetermined irradiation time (1 s to 40 s) such that the compressive residual stress of the diamond layer 7 is 50 MPa or more and 1800 MPa or less.

### EXAMPLES

Hereinafter, more detailed descriptions will be made through examples.

### 1. Preparation of Diamond Coating Cutting Tools (Examples and Comparative Examples)

### (1) Preparation of Base Material

α-Si₃N₄>powder having an average particle diameter of 1.0 μm or less, and Y₂O₃ (yttrium oxide), Yb₂O₃ (ytterbium oxide), La₂O₃ (lanthanum oxide), CeO₂ (cerium (IV) oxide), Sm₂O₃ (samarium oxide), Er₂O₃ (erbium oxide), Dy₂O₃ (dysprosium oxide), MgO (magnesium oxide), MgCO₃ (magnesium carbonate), Al₂O₃ (aluminum oxide), AlN (aluminum nitride), ZrO₂ (zirconium oxide), TiN (titanium nitride), or TiC (titanium carbide), which is a sintering aid, were weighed to prepare raw material powders so as to be blended as shown in Table 1. In the columns of “Sintering aid A” and “Sintering aid B” in Table 1, upper rows indicate the names of compounds, and lower rows indicate blending amounts (% by mass).

A raw material powder, a micro-wax-based organic binder dissolved in ethanol, and ethanol were wet-mixed by a ball mill using balls made of Si₃N₄ to obtain a slurry. The slurry was dried and press-molded into a shape of SPGN422 according to ISO standards to obtain a molded product.

The molded product was subjected to a degreasing treatment in the heating device in a nitrogen atmosphere of 1 atm at 400° C. to 800° C. for 60 minutes to 120 minutes. Moreover, the degreased molded product was disposed in a container made of Si₃N₄, and heated in a nitrogen atmosphere at 1,700° C. to 1,900° C. for 120 minutes to 360 minutes to obtain a sintered body. In a case where the theoretical density of the sintered body was less than 99%, the sintered body was further subjected to the HIP treatment in a nitrogen atmosphere of 1,000 atm at 1,500° C. to 1,700° C. for 120 minutes to 240 minutes to obtain a dense body having a theoretical density of 99% or more. The sintered body or dense body prepared in this way was used as a base material.

TABLE 1

| | Base Material | | | | | | | | | | Cutting Test | |
|---|---|---|---|---|---|---|---|---|---|---|---|---|
| | | Al | Ti | | | Average | | | | | Number | |
| | | Content | Com- | | | Thermal | | Blast Condition | | Diamond | of | |
| | | (Con- | pound | Sinter- | Sinter- | Expansion | Con- | Irradi- | Irradi- | Layer | Passes | |
| | | verted | (TiN) | ing | ing | Coeffi- | taining | ation | ation | Residual | until | |
| | | to Al₂O₃) | Content | Aid A | Aid B | cient | Second | Pressure | Time | Stress | Peeling | Evalu- |
| Sample | Type | (mass %) | (mass %) | (mass %) | (mass %) | (×10⁻⁶/K) | Phase | (MPa) | (s) | (MPa) | (Times) | ation |
| Comparative | Silicon | — | — | MgO | — | 2.4 | Absent | 0.2 | 10 | 200 | 500 | D |
| Example 1 | Nitride | | | 1.0 | | | | | | | | |
| | Sintered | | | | | | | | | | | |
| | Body | | | | | | | | | | | |
| Example 1 | Silicon | — | — | MgCO₃ | ZrO₂ | 2.6 | Absent | 0.2 | 30 | −50 | 1100 | B |
| | Nitride | | | 0.5 | 1.0 | | | | | | | |
| | Sintered | | | | | | | | | | | |
| | Body | | | | | | | | | | | |
| Example 2 | Silicon | — | — | Sm₂O₃ | MgCO₃ | 2.7 | Absent | 0.3 | 40 | −600 | 1000 | B |
| | Nitride | | | 1.2 | 3.0 | | | | | | | |
| | Sintered | | | | | | | | | | | |
| | Body | | | | | | | | | | | |
| Example 3 | Sialon | 7 | — | Y₂O₃ | — | 2.9 | Present | 0.3 | 30 | −1300 | 1400 | A |
| | Sintered | | | 5.0 | | | | | | | | |
| | Body | | | | | | | | | | | |
| Example 4 | Sialon | 23 | — | Y₂O₃ | La₂O₃ | 3.4 | Present | 0.4 | 20 | −1200 | 1800 | A |
| | Sintered | | | 3.0 | 5.0 | | | | | | | |
| | Body | | | | | | | | | | | |
| Example 5 | Sialon | 5 | 10 | Yb₂O₃ | — | 3.4 | Present | 0.1 | 20 | −200 | 1200 | B |
| | Sintered | | | 8.0 | | | | | | | | |
| | Body | | | | | | | | | | | |
| Example 6 | Sialon | 3 | 20 | Y₂O₃ | — | 3.6 | Present | 0.2 | 10 | −50 | 1100 | B |
| | Sintered | | | 8.0 | | | | | | | | |
| | Body | | | | | | | | | | | |
| Example 7 | Sialon | 34 | — | Y₂O₃ | — | 3.7 | Present | 0.5 | 20 | −1600 | 1200 | B |
| | Sintered | | | 10.0 | | | | | | | | |
| | Body | | | | | | | | | | | |
| Example 8 | Sialon | 30 | — | Sm₂O₃ | MgCO₃ | 3.9 | Present | 0.2 | 5 | −1000 | 1000 | B |
| | Sintered | | | 4.0 | 5.0 | | | | | | | |
| | Body | | | | | | | | | | | |
| Comparative | Sialon | 40 | — | Er₂O₃ | ZrO₂ | 4.2 | Absent | 0.5 | 20 | −2000 | 600 | D |
| Example 2 | Sintered | | | 5.0 | 5.0 | | | | | | | |
| | Body | | | | | | | | | | | |
| Comparative | Cemented | — | — | Co | — | 5.8 | Absent | 0.5 | 10 | −2400 | 400 | D |
| Example 3 | Carbide | | | 6.0 | | | | | | | | |

### (2) Coating

The microwave plasma CVD method was used for the coating of a diamond layer. Methane (CH₄), hydrogen (H₂), carbon monoxide (CO), or the like was used as a raw material gas. In the coating treatment, the nucleation step described in Section (4.1) and the crystal growth step described in Section (4.2) were repeated until a set film thickness (12 μm) was reached, and a diamond layer having a multilayer structure was coated on the surface of the base material.

### (3) Coating Post-Treatment

The coated diamond layer was subjected to the blast treatment using SiC abrasive grains having a particle size of #600. The irradiation pressure (MPa) and the irradiation time (s, seconds) in the blast treatment were the conditions described in Table 1.

### 2. Method of Measuring Diamond Coating Cutting Tool, or the Like

### (1) Method of Calculating Content of Al as Converted to Oxide and Content of Ti Compound

The content of Al as converted to oxide and the content of a Ti compound were calculated by measuring fluorescent X-rays (performing X-ray fluorescence spectrometry) on the base material.

The Ti compound herein means at least one selected from Ti nitride, Ti carbide, or Ti carbonitride. The columns of “Al content” and “Ti compound (TiN) content” in Table 1 represent the content of Al as converted to oxide and the content of the Ti compound, which was calculated. “-” means that the Al compound or the Ti compound was a detection limit or less.

### (2) Crystal Phase Identification Method

The second phase in the sintered body was identified by performing the X-ray diffraction analysis on the base material. Here, the second phase is specified as a phase containing at least one selected from the group consisting of Ti nitride, Ti carbonitride, Ti carbide, 12H-sialon, 15R-sialon, 21R-sialon, and α-sialon.

Each example in which the column of “Second phase contained” in Table 1 was “present” included the first phase containing β-silicon nitride or β-sialon and the above second phase.

### (3) Thermal Expansion Coefficient Measurement Method

A measurement was performed using the thermo mechanical analysis (TMA) on each base material. The measurement conditions were R.T. (25° C.) to 1000° C., under an Ar atmosphere, and 10° C./min.

### (4) Residual Stress Measurement Method

The residual stress of the diamond layer was measured by the sin²Ψ method. The measurement point was a position of 1500 μm from a cutting edge of a diamond coating cutting tool on a rake face of the diamond coating cutting tool. The residual stress was measured by the X-ray diffraction device using Cu-Kα rays through an ISO-inclination method.

### Measurement Conditions

Peak used: C (331)
Young's modulus: 1050 GPa
Poisson's ratio (v): 0.2
Collimator diameter: 0.3 mm
Measurement: Ψ was measured at 15 points such that sin²Ψ has equal intervals in a range of −43.1069° to 0°.

### 3. Cutting Test of Diamond Coating Cutting Tool

### (1) Test Method

A cutting test was performed using each diamond coating cutting tool. The test conditions are as follows. In the cutting test, the number of passes until a diamond layer was peeled off from the diamond coating cutting tool was measured. The higher the number of passes, the higher the evaluation. The evaluation was performed as follows.

### Test Conditions

Workpiece: aluminum material (AC4A-T6)
Cutting speed: 300 m/min
Depth of cut: 1.0 mm
Feed amount: 0.25 mm/rev
Length per one pass: 200 mm
Cutting environment: with cooling water

### Evaluation

“A”: 1,400 passes or more
“B”: 1,000 passes or more and less than 1,400 passes
“C”: 900 passes or more and less than 1,000 passes
“D”: less than 900 passes

### (2) Test Results

The test results are shown in Table 1.

In Examples 1 to 8 in which the average thermal expansion coefficient x satisfied 2.6×10⁻⁶/K≤x≤4.0×10⁻⁶/K and the diamond layer had a compressive residual stress of 50 MPa or more and 1,800 MPa or less, all of the examples had an excellent evaluation of “A” or “B”. In contrast, in Comparative Examples 1 to 3 in which the average thermal expansion coefficient x was not 2.6×10⁻⁶/K≤x≤4.0×10⁻⁶/K, or the diamond layer did not have a compressive residual stress of 50 MPa or more and 1,800 MPa or less, all of the comparative examples had an evaluation of “D” which was not excellent. More specifically, in Examples 1 to 8, the number of passes until peeling was at least 1,000 times, whereas in Comparative Examples 1 to 3, the number of passes until peeling was 600 times even in a case where the number of passes until peeling was large, and the peeling resistance was significantly different.

Comparing Example 2 with Example 3, Example 3 including the first phase and the second phase had a higher evaluation than Example 2 not including the second phase.

Comparing Example 2, Example 3, and Example 4, Example 3 and Example 4 in which Al was contained in 2% by mass or more and 35% by mass or less as converted to oxide had an evaluation higher than that of Example 2 outside this range.

Comparing Examples 2, 5, and 6, Examples 5 and 6 in which the Ti nitride (TiN) was contained in 5% by mass or more and 20% by mass or less had a larger number of passes until peeling than that in Example 2 outside this range.

The present disclosure is not limited to the embodiments described in detail above, and various modifications or changes are possible within the scope set forth in the claims of the present disclosure.

### REFERENCE SIGNS LIST

1: diamond coating cutting tool
3: base material
7: diamond layer
7A: surface

1. A diamond coating cutting tool comprising:
a base material made of a silicon nitride sintered body or a sialon sintered body; and
a diamond layer coated on a surface of the base material,
wherein an average thermal expansion coefficient x of the base material in a temperature range of 25° C. to 600° C. satisfies 2.6×10˜⁶/K≤x≤4.0×10⁻⁶/K, and
the diamond layer has a compressive residual stress of 50 MPa or more and 1800 MPa or less.

2. The diamond coating cutting tool according to claim 1,
wherein the silicon nitride sintered body or the sialon sintered body of the base material includes
a first phase that contains β-silicon nitride or β-sialon, and
a second phase that contains at least one selected from the group consisting of a Ti nitride, a Ti carbonitride, a Ti carbide, 12H-sialon, 15R-sialon, 21R-sialon, and α-sialon.

3. The diamond coating cutting tool according to claim 1,
wherein the silicon nitride sintered body or the sialon sintered body of the base material is
a silicon nitride sintered body that contains Al in 2% by mass or more and 35% by mass or less as converted to oxide, or
a sialon sintered body that contains Al in 2% by mass or more and 35% by mass or less as converted to oxide.

4. The diamond coating cutting tool according to claim 1,
wherein the silicon nitride sintered body or the sialon sintered body of the base material is
a silicon nitride sintered body that contains at least one selected from a Ti nitride, a Ti carbonitride, and a Ti carbide in a total of 5% by mass or more and 20% by mass or less, or
a sialon sintered body that contains at least one selected from a Ti nitride, a Ti carbonitride, and a Ti carbide in a total of 5% by mass or more and 20% by mass or less.
